(19) United States
(12) Patent Application Publication
(10) Pub. No.: US 2008/0245893 A1
(43) Pub. Date: Oct. 9, 2008

(54) SELF-CLEANING SPRINKLER

(76) Inventor: Jacob F. Hiebert, Reedley, CA (US)

Correspondence Address: MADSON & AUSTIN, 15 WEST SOUTH TEMPLE, SUITE 900, SALT LAKE CITY, UT, 84101, US

(21) Appl. No.: 12/143,495

(22) Filed: Jun. 20, 2008

Related U.S. Application Data
(63) Continuation-in-part of application No. 11/943,795, filed on Nov. 21, 2007.
(60) Provisional application No. 60/866,789, filed on Nov. 21, 2006.

(51) Int. Cl. B05B 15/02

(52) U.S. Cl. 239/123

(57) ABSTRACT

A self-cleaning sprinkler is disclosed. The self-cleaning sprinkler includes a housing having an internal chamber. The internal chamber defines an interior scraping surface. A rotatable spool is disposed within the internal chamber. The spool includes external threads, defining a spiral passageway. A spacer extending from the spool that maintains the spool at a distance from a wall of the internal chamber to create an exit chamber is included. Pressurized fluid passing through the spiral passageway causes the spool to rotate. As the spool rotates, debris is compressed between the threads and the scraping surface, breaking the debris up into smaller pieces.

### RELATED APPLICATIONS

This application is a continuation-in-part of U.S. patent application Ser. No. 11/943,795, filed Nov. 21, 2007, for SELF-CLEANING SPRINKLER, with inventor Jacob F. Hiebert, which is hereby incorporated by reference and is related to and claims priority from U.S. Provisional Patent Application Ser. No. 60/866,789 filed Nov. 21, 2006, for SELF-CLEANING SPRINKLER, with the inventor Jacob F. Hiebert, which is also incorporated herein by reference.

### FIELD OF THE INVENTION

The present invention relates to a sprinkler and, in particular, to a self-cleaning sprinkler.

### BACKGROUND

Sprinklers are available in a wide variety of types and sizes for distributing water or other fluids to vegetation. Sprinklers can also be used in other applications. For example, sprinklers may be used within an office building to extinguish or limit the spread of a fire.

One problem with conventional sprinklers is that debris, including mineral deposits, can accumulate within the sprinklers, impeding the flow of fluid through these devices. For example, if the fluid passing through the sprinkler has a high mineral concentration, fluid passageways of the sprinkler can become partially or completely clogged by mineral deposits in a relatively short period of time. A similar scenario can occur if the fluid received by the sprinkler has debris interspersed therein.

Manual cleaning of the sprinklers is time-consuming and frequently ineffective. It is often difficult if not impossible to clean small channels within a sprinkler. Furthermore, once a sprinkler is clogged, consumers may believe that a product is poorly designed and switch to a different brand of sprinkler.

Accordingly, a need exists for a self-cleaning sprinkler. A need further exists for a self-cleaning sprinkler that will operate reliably for a long period of time.

### BRIEF SUMMARY OF THE INVENTION

The present invention has been developed in response to the present state of the art and, in particular, in response to the problems and needs in the art that have not yet been fully solved by currently available sprinklers.

The self-cleaning sprinkler disclosed herein includes a housing having an internal chamber. The internal chamber defines an interior scraping surface, such as a surface with peaks and valleys. A rotatable spool is disposed within the internal chamber. The spool includes external threads that define a spiral passage way. The spiral passageway is proximate the scraping surface of the housing. One or more angled exit channels and a receiving chamber are in fluid communication with the passage way.

Pressurized fluid traveling through the passageway and the angled internal channel applies offset, rotational force to the spool, causing the spool to rotate. The rotation of the spool causes debris (e.g., mineral deposits or other debris within the pressurized fluid) to scrape the scraping surface, as the threads press the debris against scraping surface. The debris is thereby broken into smaller pieces.

Thus, the self-cleaning sprinkler breaks up debris to enable fluid to more freely pass through the sprinkler and prevent hard water deposits, or other foreign objects, from impeding the flow of the pressurized fluid.

In one embodiment of the self-cleaning sprinkler, a spacer extending from the spool maintains the spool at a distance from a wall of the internal chamber to create an exit chamber. The exit chamber allows fluid to further be churned resulting in further disintegration of debris within the fluid.

These and other features of the present invention will become more fully apparent to those skilled in the art from the following description.

### BRIEF DESCRIPTION OF THE DRAWINGS

In order that the manner in which the above-recited and other advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 is partial cross-sectional view of one embodiment of a self-cleaning sprinkler;

FIG. 2 is a sectional view of the self-cleaning sprinkler of FIG. 1 across the line 2-2;

FIG. 3 is a bottom view of one embodiment of a threaded spool for the self-cleaning sprinkler;

FIG. 4 is an exploded view of one embodiment of the self-cleaning sprinkler assembly with a sectional view of the housing;

FIG. 5 is partial cross-sectional view of another embodiment of the self-cleaning sprinkler; and

FIG. 6 is a bottom view of an embodiment of a threaded spool for the self-cleaning sprinkler shown in FIG. 5.

### DETAILED DESCRIPTION OF THE PREFERRED EMBODIMENTS

The following description of several exemplary embodiments of the present invention, as disclosed below, is not intended to limit the scope of the invention, but is merely representative of the embodiments of the invention.

The word “exemplary” is used exclusively herein to mean “serving as an example, instance, or illustration.” As used herein the term “embodiment” may refer to one or more different variations of the disclosed invention and does not necessarily refer to a single variation of the disclosed invention.

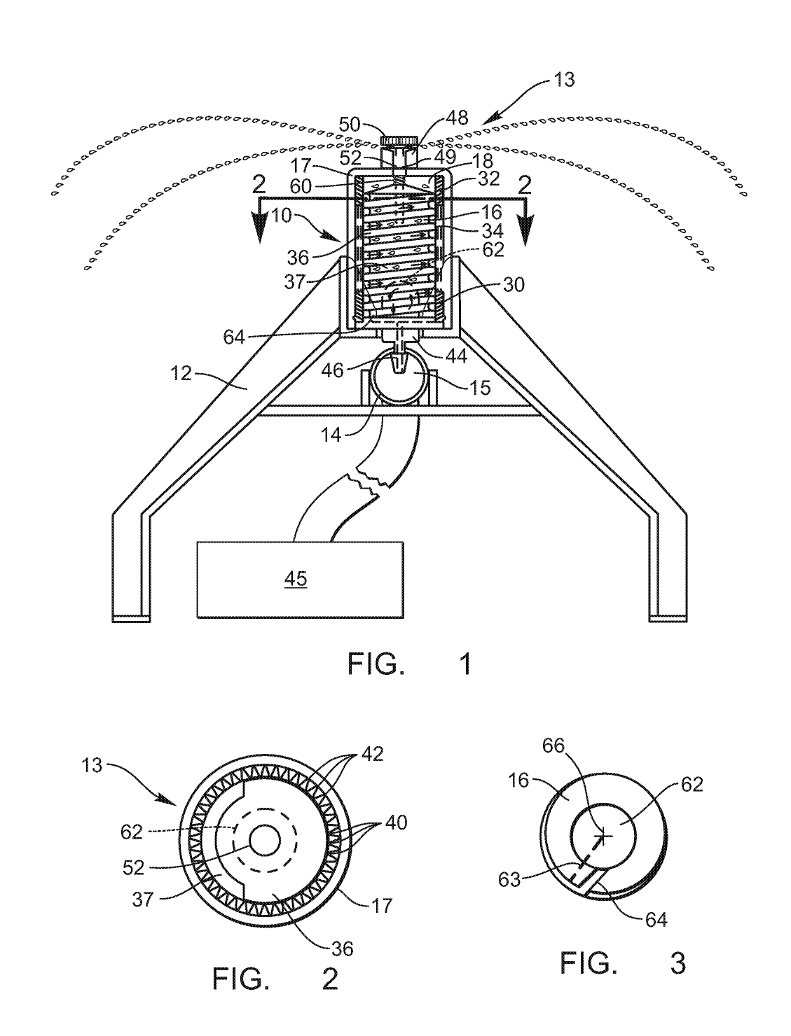

With reference to FIG. 1, a partial cross-sectional view of one embodiment of a self-cleaning sprinkler 10 is illustrated. In particular, this figure shows a side view of a sprinkler stand 12, and a cross-sectional view of the sprinkler assembly 13 and tubing 14 by which pressurized fluid 15 is provided to the sprinkler 10.

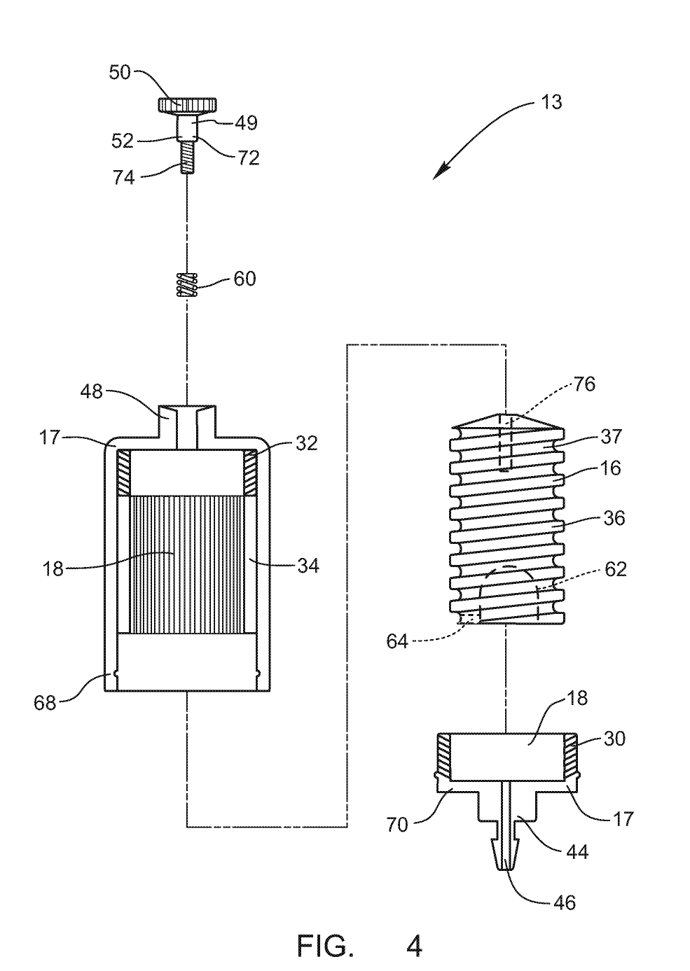

FIG. 1 should also be considered with reference to FIGS. 2 and 3, which illustrate specific features of the sprinkler 10. FIG. 2 is a sectional view of the self-cleaning sprinkler assembly 13 of FIG. 1 across the line 4-4, and FIG. 3 is a bottom view of one embodiment of a threaded spool 16 for the self-cleaning sprinkler 10. FIGS. 2 and 3 will be referenced at appropriate locations during the discussion of FIG. 1 to illustrate the specific features of the sprinkler 10.

Referring once again specifically to FIG. 1, the stand 12 used with the sprinkler assembly 13 may be embodied in various ways within the scope of this invention. Furthermore, the stand 12 itself may be omitted where the sprinkler assembly 13 is, for example, positioned in the ground.

The sprinkler assembly 13 includes a housing 17 having an internal chamber 18. The internal chamber 18 is defined by at least a first barrier region 30, a second barrier region 32, and a scraping surface 34 interposed between the first and second barrier regions 30, 32.

The first and second barrier regions 30, 32 generally abut the spool 16 disposed within the internal chamber 18. More specifically, the first and second barrier regions 30, 32 abut the external threads 36 of the spool 16 to substantially maintain the flow of fluid 15 in the spiral passageway 37 defined by the threads 36 where the threads 36 abut these barrier regions 30, 32. The barrier regions 30, 32 also serve to maintain the spool 16 in generally the same position as it rotates so that it will not wobble during rotation.

The scraping surface 34 is used to compress or crush debris between the threads 36 and the scraping surface 34, and thus may be embodied in various ways to achieve this purpose. The scraping surface 34, defined generally, is an uneven surface that includes protrusions and recesses for retaining and breaking up debris. In one embodiment, the scraping surface 34 may comprise a series of linear peaks 40 and valleys 42, as illustrated in FIG. 2. With reference again to FIG. 1, the scraping surface 34 may alternatively comprise a series of conical peaks (not shown) arranged in a regular or irregular pattern. The scraping surface 34 may also, by way of example, comprise a series of elongated peaks and valleys arranged in a linear, nonlinear, regular, or irregular pattern. The peaks or other protrusions may be generally directed inward toward the spool 16. These protrusions may be sharp or pointed to enhance the cutting or crushing action performed by the scraping surface 34.

The sprinkler assembly 13 also includes a fluid inlet 44 through which pressurized fluid 15 is received into the housing 17 from, for example, the tubing or pipe 14 in fluid communication with a fluid source 45. In the illustrated embodiment, a barb 46 is utilized to communicate pressurized fluid from the tubing 14 into the housing 17. Of course, skilled artisans will appreciate that many different techniques and systems may be used to transmit fluid 15 from the tubing 14 to the sprinkler assembly 13.

The housing 17 also includes a fluid outlet 48 through which fluid 15 exits the internal chamber 18 and the sprinkler 10. A flow regulator 49 is positioned within the fluid outlet 48. The flow regulator 49 has a head 50 and an elongated extension 52. The elongated extension 52 is positioned within the fluid outlet 48. In one embodiment, the elongated extension 52 is threadably coupled to the spool 16. In such an embodiment, adjustment of the distance between the head 50 of the flow regulator 49 and the spool 16 will affect the flow pattern of fluid 15 exiting the sprinkler assembly 13.

A spring 60 is disposed around the elongated extension 52. The spring 60 is positioned between the spool 16 and a wall of the internal chamber 18 to bias the flow regulator 49 in a closed position. This biasing action mitigates the possibility that small insects, spiders, and other debris will enter the sprinkler assembly 13 when the sprinkler 10 is not in use.

With reference to FIGS. 1 and 3, the spool 16 is disposed within the internal chamber 18. The spool 16 has external threads 36, a receiving chamber 62, and an angled exit channel 64 (shown in FIG. 3). The spool 16 is designed to pivot around the elongated extension 52 of the flow regulator 49. The spool 16 may be embodied in various ways and may have, for example, a generally circular (as shown) or octagonal cross-sectional shape. The threads 36 enable fluid 15 to pass into the spiral passageway 37 between the threads 36.

The receiving chamber 62 of the spool 16 receives fluid 15 into the housing 17 after the fluid 15 passes through the fluid inlet 44. The receiving chamber 62 illustrated in FIG. 1 is dome shaped. However, other shapes, such as a rectangular shape or square shape, may be used within the scope of this invention. In one embodiment, the receiving chamber 62 is omitted.

Fluid 15 passing from the receiving chamber 62 moves through an angled exit channel 64 and then into the spiral passageway 37 between the threads 36. In one embodiment, as illustrated in FIG. 3, the exit channel 64 is angled with respect to a radial line 63 from the center 66 of the spool 16. Directing the fluid 15 to exit in this angled course applies an offset force to the spool 16, to aid in causing the spool 16 to rotate.

Referring once again to FIG. 1, the self-cleaning sprinkler 10 operates in the following manner. Fluid 15 passes from the tubing 14 through the fluid inlet 44 into the internal chamber 18. More specifically, the fluid 15 moves into the receiving chamber 62 of the spool 16. The fluid 15 exits the receiving chamber 62 through the angled exit channel 64, to aid in causing the spool 16 to rotate. The fluid 15 moves in the spiral passageway 37 between the threads 36 by the force of the fluid pressure. The passage of pressurized fluid 15 through the spiral passageway 37 applies a rotational, or tangential, force to the spool 16, causing the spool 16 to rotate, as the fluid 15 exits the angled exit channel 64.

The fluid 15 remains in the spiral passageway 37 where the spool 16 abuts the first barrier region 30. When the fluid 15 reaches the portion of the spool 16 abutting or near the scraping surface 34, a portion of the fluid 15 may move outside of the spiral passageway 37 filling that portion of the internal chamber 18 near the scraping surface 34. The centrifugal force of the rotating spool 16 acts on the debris suspended in the fluid 15, sending the debris into the scraping surface 34. Further, churning of the fluid 15 within the space between the spool 16 and scraping surface 34 (including valleys or recesses in the scraping surface 34) will also assist in breaking up debris. At this point, debris within the fluid 15 will be compressed between the threads 36 and the scraping surface 34 as the spool 16 rotates. This action will break up the debris into smaller pieces so that it can pass through the remaining path of the fluid 15 without impeding the passage of fluid 15 through the sprinkler assembly 13.

The fluid pressure drives the fluid 15 into the portion of the threads 36 abutting or near the second barrier region 32. In this section, the fluid 15 is confined generally to the spiral passageway 37 between the threads 36. The fluid 15 then passes out of the top of the spool 16 and between the head 50 of the flow regulator 49 and a fluid outlet 48.

FIG. 4 is an exploded view of one embodiment of the self-cleaning sprinkler assembly 13. This exploded view more clearly explains and illustrates each of the component parts of the self-cleaning sprinkler assembly 13. As indicated above, the self-cleaning sprinkler assembly 13 includes a flow regulator 49, a spring 60, a housing 17 having a first and second portion 68, 70 in this exemplary embodiment, and a spool 16.

The illustrated flow regulator 49 is generally T-shaped when viewed from the side. It has a head 50 and an elongated extension 52. In the illustrated example, the elongated extension 52 further comprises a smooth region 72 and a threaded region 74. The threaded region 74 mates with a threaded recess 76 on the spool 16. Of course, alternative methods may be utilized to adhere the flow regulator 49 to the spool 16, such as by using adhesives or ultrasonic welding.

As explained in detail above, the housing 17 comprises a first barrier region 30, a second barrier region 32, and an intermediary scraping surface 34. In FIG. 4, the housing 17 comprises a first and a second portion 68, 70. The first and second portions 68, 70 of the housing 17 may be attached together after the spool 16 has been positioned within the internal chamber 18 for easy assembly. Again, those skilled in the art will appreciate that the parts of the housing 17 may be attached to each other in a number of different ways and may also be designed in a number of different ways within the scope of this invention.

The housing 17 also comprises a fluid inlet and outlet 44, 48. In the illustrated embodiment, the fluid inlet 44 includes a barb 46 for interfacing with a pipe or tube 14 (shown in FIG. 1).

The spool 16 has external threads 36, a receiving chamber 62, and an angled exit channel 64 (shown in phantom). The outward extending threads 36 provide a spiral passageway 37 through which the fluid 15 (shown in FIG. 1) can pass from the angled exit channel 64 by the first barrier region 30, the scraping surface 34, and the second barrier region 32.

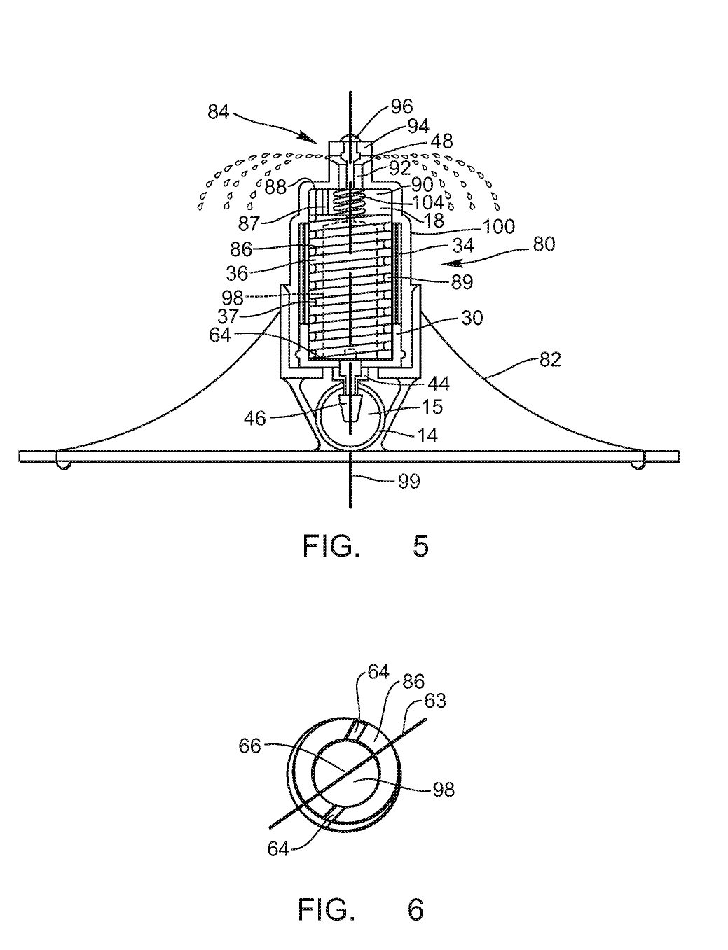

With reference to FIG. 5, a partial cross-sectional view of an alternative embodiment of a self-cleaning sprinkler 80 is illustrated. In particular, this figure shows a side view of a sprinkler stand 82, and a cross-sectional view of the sprinkler assembly 84 and tubing 14 by which pressurized fluid 15 is provided to the sprinkler 80.

FIG. 1 should also be considered with reference to FIG. 6, which is a bottom view of one embodiment of a threaded spool 86 for the self-cleaning sprinkler 80. FIG. 6 will be referenced at appropriate locations during the discussion of FIG. 5 to illustrate the specific features of the sprinkler 80.

In overview, the embodiment shown in FIGS. 5 and 6 operates in a manner similar to the embodiments shown in FIGS. 1-4. The embodiment of FIGS. 5 and 6, however, differs in that it includes the following features. The second barrier region 32 shown in the embodiments in FIGS. 1-4 is omitted. Also, one or more spacers 87 extending from the spool 86 separate the spool 86 from a wall 88 in the internal chamber 18 to create an exit chamber 90. The spool 86 also includes a fastener receiving extension 92 that may be secured to a regulating head 94 using a fastener 96, such as a screw (as shown). The embodiments of FIGS. 5 and 6 also include a plurality of angled exit channels 64 and an enlarged receiving chamber 98. Of course, as will be appreciated by those of skill in the art, the features shown in the embodiments of all figures of this application may be combined in various ways, not merely in the ways shown in FIGS. 1-6. For example, the embodiments shown in FIGS. 1-4 may utilize a plurality of angled exit channels 64 or an enlarged receiving chamber 98.

Referring once again specifically to FIG. 5, the stand 82 used with the sprinkler assembly 84 may be embodied in various ways within the scope of this invention. Furthermore, the stand 82 itself may be omitted where the sprinkler assembly 84 is, for example, positioned in the ground.

The sprinkler assembly 84 includes a housing 100 having an internal chamber 89. The internal chamber 89 is defined by at least a first barrier region 30 and a scraping surface 34. As noted above, unlike the embodiment of FIGS. 1-4, a second barrier region 32 is not present.

The first barrier region 30 generally abuts the spool 86 disposed within the internal chamber 89. More specifically, the first barrier region 30 abuts the external threads 36 of the spool 86 to substantially maintain the flow of fluid 15 in the spiral passageway 37 defined by the threads 36 where the threads 36 abut the barrier region 30. The barrier region 30 also serves to maintain the spool 86 in generally the same position as it rotates so that it will not wobble during rotation.

As with the embodiment of FIG. 1, the scraping surface 34 is used to compress or crush debris between the threads 36 and the scraping surface 34, and thus may be embodied in various ways to achieve this purpose.

The sprinkler assembly 84 also includes a fluid inlet 44 through which pressurized fluid 15 is received into the housing 100 from, for example, the tubing or pipe 14. In the illustrated embodiment, a barb 46 is utilized to communicate pressurized fluid from the tubing 14 into the housing 100. As noted above, skilled artisans will appreciate that many different techniques and systems may be used to transmit fluid 15 from the tubing 14 to the sprinkler assembly 84.

The housing 100 also includes a fluid outlet 48 through which fluid 15 exits the internal chamber 89 and the sprinkler 80. The fastener receiving extension 92 and the regulating head 94, secured together by a fastener 96 or an adhesive, are positioned within the fluid outlet 48.

A spring 104 is disposed around the fastener receiving extension 92, which may be integrally formed with the spool 86 or may be secured to the spool 86. The spring 104 is positioned between the spool 86 and a wall of the internal chamber 89 to bias the flow regulating head 94 in a closed position. As before, this biasing action mitigates the possibility that small insects, spiders, and other debris will enter the sprinkler assembly 84 when the sprinkler 80 is not in use.

With reference to FIGS. 5 and 6, the spool 86 is disposed within the internal chamber 89. The spool 86 has external threads 36, an enlarged receiving chamber 98, and two angled exit channels 64. The spool 86 pivots around the center 66, or longitudinal axis 99, of the spool 86. As with other embodiments, the spool 86 may be embodied in various ways and may have, for example, a generally circular (as shown) or octagonal cross-sectional shape. The threads 36 enable fluid 15 to pass into the spiral passageway 37 between the threads 36.

The enlarged receiving chamber 98 of the spool 16 receives fluid 15 into the housing 100 after the fluid 15 passes through the fluid inlet 44. The enlarged receiving chamber 98 may be embodied in various shapes within the scope of this invention. Also, in one embodiment, the receiving chamber 62 is omitted. The enlarged receiving chamber 98 enables the debris within the fluid to be further broken up, caused by the increased volume and churning within the enlarged chamber 98.

Fluid 15 passing from the receiving chamber 98 moves through the angled exit channels 64 and then into the spiral passageway 37 between the threads 36. In one embodiment, as illustrated in FIGS. 3 and 6, the exit channels 64 are angled with respect to a radial line 63 from the center 66 of the spool 86. Directing the fluid 15 to exit in this angled course applies an offset force to the spool 86, to aid in causing the spool 86 to rotate.

One or more spacers 87 extending from the spool 86 separates the spool 86 from a wall 88 of the internal chamber 89 to create an exit chamber 90. The exit chamber 90 enables further churning of the fluid 15 to further disintegrate debris within the fluid 15.

Referring once again to both FIGS. 5 and 6, the self-cleaning sprinkler 80 operates in the following manner. Fluid 15 passes from the tubing 14 through the fluid inlet 44 into the internal chamber 89. More specifically, the fluid 15 moves into the enlarged receiving chamber 98 of the spool 86. The fluid 15 exits the enlarged receiving chamber 98 through the angled exit channels 64, to aid in causing the spool 86 to rotate. The fluid 15 moves in the spiral passageway 37 between the threads 36 by the force of the fluid pressure. The passage of pressurized fluid 15 through the spiral passageway 37 applies a rotational, or tangential, force to the spool 86, causing the spool 86 to rotate, as the fluid 15 exits the angled exit channels 64.

The fluid 15 remains in the spiral passageway 37 where the spool 86 abuts the first barrier region 30. When the fluid 15 reaches the portion of the spool 86 abutting or near the scraping surface 34, a portion of the fluid 15 may move outside of the spiral passageway 37, filling that portion of the internal chamber 89 near the scraping surface 34. The centrifugal force of the rotating spool 86 acts on the debris suspended in the fluid 15, sending the debris into the scraping surface 34. Further, churning of the fluid 15 within the space between the spool 86 and scraping surface 34 (including valleys or recesses in the scraping surface 34) will also assist in breaking up debris. At this point, debris within the fluid 15 will be compressed between the threads 36 and the scraping surface 34 as the spool 86 rotates. This action will break up the debris into smaller pieces so that it can pass through the remaining path of the fluid 15 without impeding the passage of fluid 15 through the sprinkler assembly 84.

The fluid pressure drives the fluid 15 into the exit chamber 90, resulting in further churning and breaking up of the debris. The fluid 15 then passes out of the fluid outlet 48 as fluid pressure dislodges the regulating head 94, counterbalancing the biasing force of the spring 104.

While specific embodiments and applications of the present invention have been illustrated and described, it is to be understood that the invention is not limited to the precise configuration and components disclosed herein. Various modifications, changes, and variations, which will be apparent to those skilled in the art, may be made in the arrangement, operation, and details of the methods and systems of the present invention disclosed herein without departing from the spirit and scope of the invention.

1. A self-cleaning sprinkler for connection to a source that conveys pressurized fluid to the sprinkler, comprising:
a housing having an internal chamber and an interior scraping surface;
a rotatable spool disposed within the internal chamber, the spool comprising external threads defining a spiral passageway proximate the scraping surface of the housing, wherein the pressurized fluid traveling through the spiral passageway causes the spool to rotate causing debris to scrape the scraping surface and to be broken into smaller pieces; and
a spacer extending from the spool that maintains the spool at a distance from a wall of the internal chamber to create an exit chamber.

2. The sprinkler of claim 1, wherein the spool further comprises at least two angled exit channels in fluid communication with the spiral passageway.

3. The sprinkler of claim 1, wherein the scraping surface comprises protrusions and recesses.

4. The sprinkler of claim 1, wherein the scraping surface comprises linear peaks and valleys.

5. The sprinkler of claim 1, further comprising a fastener receiving extension of the spool, the fastener receiving extension being positioned within a fluid outlet through which fluid exits the internal chamber.

6. The sprinkler of claim 5, wherein the fastener receiving extension is secured to a flow regulator head.

7. The sprinkler of claim 6, further comprising a spring disposed around the fastener receiving extension and between the spool and a wall of the internal chamber to bias the flow regulator in a closed position.

8. A self-cleaning sprinkler in fluid communication with a source that conveys pressurized fluid to the sprinkler, comprising:
a housing having an internal chamber defined by at least:
a first barrier region; and,
an interior scraping surface interposed between the first and the second barrier regions; and
a rotatable spool disposed within the internal chamber, the spool comprising external threads defining a spiral passageway proximate the scraping surface of the housing and at least two angled exit channels in fluid communication with the passageway, wherein the pressurized fluid traveling through the spiral passageway and angled exit channels causes the spool to rotate causing debris to scrape the scraping surface and to be broken into smaller pieces.

9. The sprinkler of claim 8, further comprising a spacer extending from the spool that maintains the spool at a distance from a wall of the internal chamber to create an exit chamber.

10. The sprinkler of claim 8, further comprising a fastener receiving extension of the spool, the fastener receiving extension being positioned within a fluid outlet through which fluid exits the internal chamber.

11. The sprinkler of claim 10, wherein the fastener receiving extension is secured to a flow regulator head.

12. The sprinkler of claim 11, further comprising a spring disposed around the fastener receiving extension and between the spool and a wall of the internal chamber to bias the flow regulator in a closed position.

13. The sprinkler of claim 8, wherein the housing further comprises an inlet port having a barb through which the pressurized fluid enters the internal chamber.

14. A self-cleaning sprinkler for connection to a source that conveys pressurized fluid to the sprinkler, comprising:
a housing having an internal chamber defined by at least:
a first barrier region; and,
an interior scraping surface interposed between the first and the second barrier regions; and
a rotatable spool disposed within the internal chamber, the spool comprising an external threads defining a spiral passageway proximate the scraping surface of the housing and at least two angled exit channels and receiving chamber in fluid communication with the passageway, wherein pressurized fluid traveling through the spiral passageway and angled exit channels causes the spool to rotate causing debris to scrape the scraping surface and to be broken into smaller pieces.

15. The sprinkler of claim 14, further comprising a spacer extending from the spool that maintains the spool at a distance from a wall of the internal chamber to create an exit chamber.

16. The sprinkler of claim 14, wherein the scraping surface comprises protrusions and recesses.

17. The sprinkler of claim 14, wherein the scraping surface comprises linear peaks and valleys.

18. The sprinkler of claim 17, further comprising a fastener receiving extension of the spool, the fastener receiving extension being positioned within a fluid outlet through which fluid exits the internal chamber.

19. The sprinkler of claim 18, wherein the fastener receiving extension is secured to a flow regulator head.

20. The sprinkler of claim 19, further comprising a spring disposed around the fastener receiving extension and between the spool and a wall of the internal chamber to bias the flow regulator in a closed position.
